(19) United States
(12) Patent Application Publication
(10) Pub. No.: US 2022/0142262 A1
(43) Pub. Date: May 12, 2022

(54) Atomization Assembly and Manufacturing Method Therefor

(71) Applicant: O-NET AUTOMATION TECHNOLOGY (SHENZHEN) LIMITED, Shenzhen (CN)

(72) Inventors: Dianyu JIANG, Shenzhen (CN); Huihua HUANG, Shenzhen (CN); Meiling GUO, Shenzhen (CN); Jian WANG, Shenzhen (CN); Bo ZHOU, Shenzhen (CN)

(73) Assignee: O-NET AUTOMATION TECHNOLOGY (SHENZHEN) LIMITED, Shenzhen (CN)

(21) Appl. No.: 17/440,204

(22) PCT Filed: Mar. 20, 2019
(86) PCT No.: PCT/CN2019/078921

§ 371 Date: Sep. 17, 2021

(51) Int. Cl. A24F 40/70; A24F 40/46; A24F 40/10; A24F 40/42

(52) U.S. Cl. CPC A24F 40/70; A24F 40/42; A24F 40/10; A24F 40/46

(57) ABSTRACT

Disclosed are an atomization assembly and a manufacturing method therefor. The atomization assembly comprises a main body (10) and a heating element (20). The main body (10) is formed with a liquid guide hole (11). The heating element (20) includes a first surface and a second surface opposite to each other, and is disposed at the liquid guide hole (11) with the first surface contacting the main body (10). The heating element (20) is a sheet structure that is able to cover the main body to the maximum extent, so that the atomization area is enlarged. The atomization assembly is simple in structure, the production procedures are simple, automatic mass production is realized, the consistency and production efficiency of atomization assemblies are improved, and costs are reduced.

### FIELD

The invention relates to the technical field of electronic cigarettes, in particular to an atomization assembly and a manufacturing method therefor.

### BACKGROUND

Atomization assemblies in existing electronic cigarettes comprise a heating element and a liquid conducting element, and the heating element is attached to the liquid conducting element by means of winding or printing. Such atomization assemblies have the following disadvantages:

1. The atomization assembly made by means of winding is subject to constraints imposed by turns of the heating body, and thus, the area of atomization is limited and the amount of smoke vapor is small.

2. The atomization assembly made by means of printing involves too many procedures including paste preparation, printing, levelling, drying, firing, resistance control, cutting, and cleaning, is low in production efficiency, and is not suitable for cotton-containing atomization devices.

### SUMMARY

The technical issue to be settled by the invention is to provide an atomization assembly with a large atomization area, and a manufacturing method therefor.

The technical solution adopted by the invention to settle the aforesaid technical issue is as follows: an atomization assembly is used for electronic cigarettes and comprises a main body and a heating element, wherein the main body is formed with a liquid guide hole; and the heating element has a first surface and a second surface opposite to each other, and is disposed at the liquid guide hole with the first surface contacting the main body.

Preferably, the main body is provided with a receiving groove communicated with the liquid guide hole.

Preferably, the liquid guide hole is formed in the surface of one end of the main body, and the groove is formed inside the main body and penetrates through the surface of the other end of the main body.

Preferably, the heating element is a sheet structure or a mesh structure.

Preferably, the main body is a column like structure or a multiple-facet structure.

Preferably, the heating element is fixed on the main body by hot-pressing, or injection moulding in a mould.

Preferably, conductors electrically connected to an electronic cigarette power supply are disposed at two ends of the heating element, respectively.

The invention further provides a manufacturing method for an atomization assembly, comprising the following steps:

S1: preparing one or more heating elements arranged at intervals on a heating element sheet;

S2: disposing one or more main bodies arranged at intervals on a hot-pressing tool;

S3: placing the heating element sheet on the main bodies, wherein each heating element is correspondingly positioned on one main body;

S4: fixing the heating elements on the main bodies by hot-pressing; and

S5: removing margin waste of the heating element sheet by cutting to separate the heating elements from the heating element sheet and form an atomization assembly by each heating element and one main body.

Preferably, S1 further comprises: preparing one or more pairs of conductors arranged at intervals on a conductor sheet;

S3 further comprises: disposing the conductor sheet on the heating element sheet with each pair of conductors corresponding to one heating element.

The invention further provides another manufacturing method for an atomization assembly, comprising the following steps:

S1: preparing one or more heating elements arranged at intervals on a heating element sheet;

S2: placing the heating element sheet in an injection mould, wherein one or more main body cavities arranged at intervals are formed in the injection mould, and each heating element corresponds to one main body cavity;

S3: injecting molten material of the main bodies into the main body cavities of the injection mould, the molten material of the main bodies being cured in the main body cavities to form the main bodies, and the heating elements being fixed with the main bodies;

S4: taking the heating element sheet with the main bodies out of the injection mould; and

S5: removing margin waste of the heating element sheet by cutting to separate the heating elements from the heating element sheet and form an atomization assembly by each heating element and one main body.

Preferably, S1 further comprises: disposing conductors on the heating element sheet, wherein the conductors are located at two ends of each heating element.

According to the atomization assembly of the invention, the heating element is a sheet structure that is able to cover the main body to the maximum extent, so that the atomization area is enlarged. The atomization assembly is simple in structure, the production procedures are simple, automatic mass production is realized, the consistency and production efficiency of atomization assemblies are improved, and costs are reduced.

### BRIEF DESCRIPTION OF THE DRAWINGS

The invention will be further described below in conjunction with accompanying drawings and embodiments, wherein:

FIG. 1 is a three-dimensional structural view of an atomization assembly in one embodiment of the invention;

FIG. 2 is an exploded structural view of an atomization assembly in one embodiment of the invention;

FIG. 3 is a schematic diagram of the manufacturing process of an atomization assembly in Embodiment 1 of the invention; and

FIG. 4 is a schematic diagram of the manufacturing process of an atomization assembly in Embodiment 2 of the invention.

### DESCRIPTION OF THE EMBODIMENTS

To gain a better understanding of the technical features, purposes and effects of the invention, specific implementations of the invention will be described in detail below with reference to the accompanying drawings.

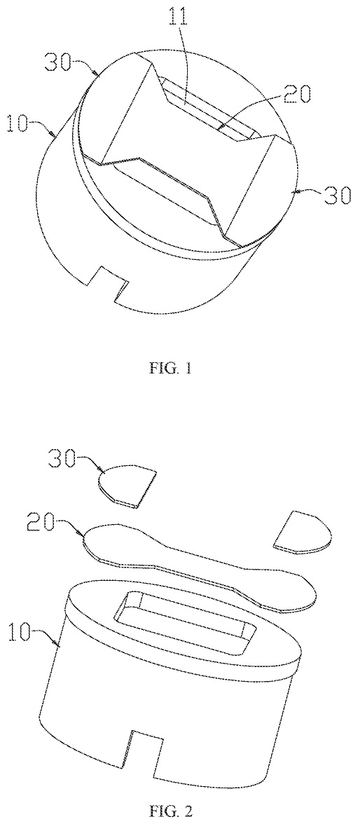

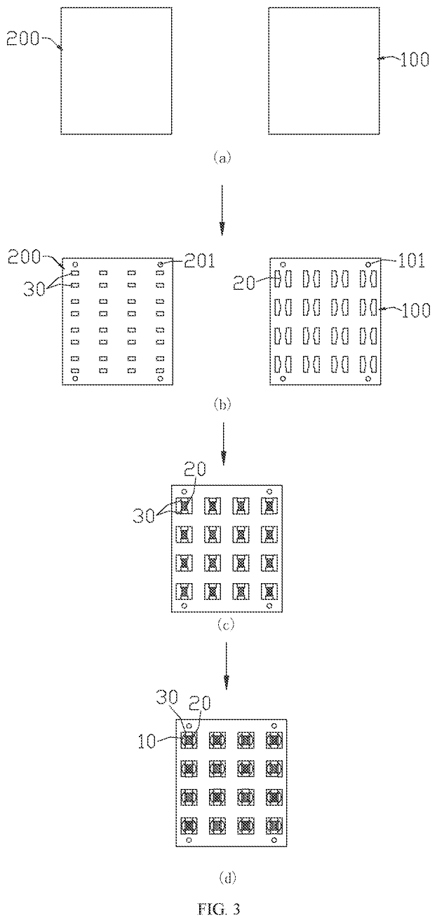

As shown in FIG. 1 and FIG. 2, one embodiment of the invention provides an atomization assembly, which is used for electronic cigarettes and comprises a main body 10 and a heating element 20 disposed on the main body 10.

Wherein, the main body 10 is configured for fixing and supporting the heating element 20, may be made of a high-temperature resistant plastic material that possesses an insulating property and does not melt when the heating element 20 is supplied with electrical power and generates heat. The main body 10 is formed with a liquid guide hole 11 allowing cigarette liquid to pass through. The main body 10 may be a column like structure with a circular or square cross section, or a multiple-facet structure.

The heating element 20 configured for heating and atomizing the cigarette liquid, is a sheet structure different from a heating wire and comprises a first surface and a second surface opposite to each other. The heating element 20 is disposed at the liquid guide hole 11 of the main body 20 with the first surface thereof contacting the main body 10, and is able to cover the liquid guide hole 11 to the maximum extent, thus enlarging the atomization area. The cigarette liquid flows onto the heating element 20 via the liquid guide hole 11, and is heated and atomized by the heating element 20 to form cigarette vapor.

A main part of the heating element 20 is located at the liquid guide hole 11 in the main body 10, and at least two ends of the heating element 20 are located on a surface of the main body 10 around the liquid guide hole 11.

The heating element 20 is a sheet structure (a solid sheet different from a mesh) or a mesh structure, and may be made of stainless steel, nickel, titanium, nichrome, aluminium, or a carbon material. The periphery of the heating element 20 may be, but is not limited to, polygonal, elliptical or circular.

Optionally, the heating element 20 is fixed on the main body 10 by hot-pressing, or injection moulding in a mould.

Furthermore, the main body 10 may be provided with a receiving groove (not shown) which is configured for receiving or positioning one end of a liquid conducting element or is connected and communicated with a liquid storage cavity in the electronic cigarette. The receiving groove is communicated with the liquid guide hole 11, so that cigarette liquid absorbed by the liquid conducting element or cigarette liquid in the liquid storage cavity sequentially flows through the receiving groove and the liquid guide hole 11 to reach the heating element 20.

In this embodiment, the liquid guide hole 11 is formed in the surface of one end of the main body 10, and the groove is formed inside the main body 10 and penetrates through the surface of the other end of the main body 10. The liquid guide hole 11 penetrates through the surface, where it is located, of the main body 10, and is communicated with the receiving groove.

Furthermore, conductors 30 configured to be electrically connected to an electronic cigarette power supply are disposed at two ends of the heating element 20, respectively. The conductors 30 may be connected to the ends of the heating element 20 with the conductors 30 being overlapped on the ends of the heating element 20, or directly connected to the periphery of ends of the heating element 20.

Corresponding to arrangement of the heating element 20 on the surface of the main body 10, the conductors 30 may be located on the surface, where the heating element 20 is located, of the main body 10. Peripheral edges of the two ends of the heating element 20 or peripheral edges of the conductors 30 may be flush with a peripheral edge of the main body 10, as shown in FIG. 1.

The conductors 30 may be made of a metal material, and thus, may be made of the same material as the heating element 20. Furthermore, the conductors 30 and the heating element 20 may be formed integrally by electroplating, brush plating or stamping.

The atomization assembly of the invention is used for electronic cigarettes, and may form an atomization device together with other components such as an atomization seat.

The atomization assemblies of the invention may be manufactured one by one or manufactured in batches. When one atomization assembly is manufactured, the main body 10, the heating element 20 and the conductors 30 are prepared in advance. The main body 10 is placed on a hot-pressing tool, then the heating element 20 and the conductors 30 are positioned on the main body 10; and finally, the conductors 30, the heating element 20 and the main body 10 are fixed together by hot-pressing to form the atomization assembly. Alternatively, the main body 10, the heating element 20 and the conductors 30 are prepared in advance, then the conductors 30 are fixed on the heating element 20, then the heating element 20 with the conductors 30 fixed thereon is placed in an injection mould, molten material of the main body 10 is poured into the injection mould and is cured to form the main body 10, and the heating element 20 is fixed on the main body 10.

In conjunction with FIG. 1-FIG. 3, a manufacturing method for an atomization assembly in accordance with a first embodiment of the invention may comprise the following steps:

S1: one or more heating elements 20 arranged at intervals are prepared on a heating element sheet 100, as shown in FIG. 3(a)-FIG. 3(b).

S1 may further comprise: one or more pairs of conductors 30 arranged at intervals are prepared on a conductor sheet 200, wherein each pair of conductors 30 comprises two conductors 30 and corresponds to one heating element 20.

S2: one or more main bodies 10 are disposed on a hot-pressing tool at intervals.

In this embodiment, the main bodies 10 are formed by injection moulding in advance.

S3: the heating element sheet 100 is disposed on the main bodies 10, wherein one heating element 20 is correspondingly positioned on one main body 10.

S3 may further comprise: the conductor sheet 200 is disposed on the heating element sheet 100 in a stacked manner, wherein each pair of conductors 30 corresponds on one heating element 20, as shown in FIG. 3(b)-FIG. 3(c).

To align the conductors 30 with the heating elements 20, positioning holes or positioning pillars 101 are disposed on the periphery of the heating element sheet 100, and positioning pillars or positioning holes 201 matched with the positioning holes or positioning pillars 101 on the periphery of the heating element sheet 100 are disposed on the conductor sheet 200.

S4: hot-pressing, the heating elements 20 are fixed on the main bodies 10 by hot-pressing, as shown in FIG. 3(d).

Optionally, the conductors 30 may be fixed on the heating elements 20 or the main bodies 10 during hot-pressing. Or, the conductors 30 are prepared on the conductor sheet 200 first and then separated from the conductor sheet 200 to be fixed on the heating elements 20 of the heating element sheet 100 by hot-pressing so that the heating element sheet 100 provided with the conductors 30 is disposed on the main bodies 10 in S3.

In addition, after the heating elements 20 are prepared on the heating element sheet 100, the conductors 30 may be prepared on the heating elements 20 by electroplating or brush plating.

S5: cutting, margin waste of the heating element sheet 100 is removed by cutting to separate the heating elements 20 from the heating element sheet 100, and an atomization assembly is formed by each heating element 20 and one main body 10.

During cutting, the heating elements 20 are separated from the heating element sheet 100 along connecting lines between the heating elements 20 and the margin waste. Laser cutting, wire cutting or shearing is used to realize cutting.

According to the manufacturing method in this embodiment, the heating elements 20 are fixed on the main bodies 10 by hot-pressing, and the manufacturing method is suitable for production of one atomization assembly as well as the mass production of multiple atomization assemblies, and is high in efficiency.

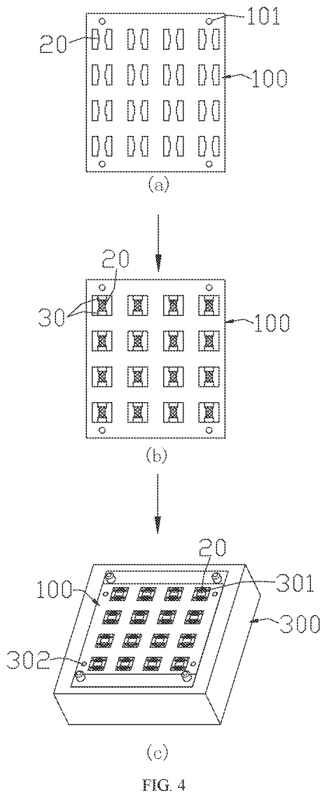

Referring, to FIG. 1, FIG. 2 and FIG. 4, a manufacturing method for an atomization assembly in accordance with a second embodiment of the invention may comprise the following steps:

S1: one or more heating elements 20 arranged at intervals are prepared on a heating element sheet 100, as shown in FIG. 4(a).

S1 may further comprise: conductors 30 are disposed on the heating element sheet 100, wherein the conductors 30 are located at two ends of each heating element 200, as shown in FIG. 4(b).

The conductors 30 may be formed at the two ends of the heating elements 20 by electroplating or brush plating; or, the conductors 30 are prepared on a conductor sheet and are then fixed on the two ends of the heating elements 20 by hot-pressing.

S2: the heating element sheet 100 is placed in an injection mould 300, wherein one or more main body cavities 301 arranged at intervals are formed in the injection mould 300, and one heating element 20 corresponds to one main body cavity 301, as shown in FIG. 4(c).

To ensure that the heating elements 20 can be accurately positioned in the main body cavities 301 when the heating element sheet 100 is placed in the injection mould 300, positioning holes or positioning pillars 101 are disposed on the periphery of the heating element sheet 100, and positioning pillars or positioning holes 302 matched with the positioning holes or positioning pillars 101 on the periphery of the heating element sheet 100 are disposed on the injection mould 300.

S3: injecting molten material of the main bodies 10 into the main body cavities 301 of the injection mould 300, the molten material being cured in the main body cavities 301 to form the main bodies 10, and the heating elements 20 being fixed on the main bodies 10.

S4: the heating element sheet with the main bodies 10 formed thereon is taken out of the injection mould 300.

S5: margin waste of the heating element sheet 100 is removed by cutting to separate the heating elements 20 from the heating element sheet 100, and an atomization assembly is formed by each heating element 20 and one main body 10.

During cutting, the heating elements 20 are separated from the heating element sheet 100 along connecting lines between the heating elements 20 and the margin waste. Laser cutting, wire cutting or shearing is used to realize cutting.

According to the manufacturing method in the above embodiment, the heating elements 20 are fixed with the main bodies 10 by injection moulding in a mould, and compared with hot-pressing, the heating elements 20 and the main bodies 10 can be fixed more firmly by injection moulding in the mould. The manufacturing method is suitable for the production of one atomization assembly as well as the mass production of multiple atomization assemblies, and is high in efficiency.

The above description is merely used to explain the embodiments of the invention, and is not intended to limit the scope of the patent of invention. All equivalent structural transformations or flow transformations made based on the contents in the specification and drawings of the invention, or direct or indirect applications to other relating technical fields should also fall within the protection scope of the patent of invention.

1. An atomization assembly, being applicable for electronic cigarettes, wherein the atomization assembly comprises a main body and a heating element, the main body is formed with a liquid guide hole, the heating element comprises a first surface and a second surface opposite to each other, and the heating element is disposed at the liquid guide hole with the first surface contacting the main body.

2. The atomization assembly according to claim 1, wherein the main body is provided with a receiving groove communicated with the liquid guide hole.

3. The atomization assembly according to claim 2, wherein the liquid guide hole is formed in a surface of an end of the main body, and the receiving groove is formed inside the main body and penetrates through a surface of another end of the main body.

4. The atomization assembly according to claim 1, wherein the main body is a column like structure or a multiple-facet structure;
the heating element is a sheet structure or a mesh structure.

5. The atomization assembly according to claim 1, wherein the heating element is fixed on the main body by hot-pressing, or injection moulding in a mould.

6. The atomization assembly according to claim 1, wherein conductors configured to be electrically connected to an electronic cigarette power supply are disposed at two ends of the heating element, respectively.

7. A manufacturing method for the atomization assembly according to claim 1, comprising the following steps:
S1: preparing one or more heating elements arranged at intervals on a heating element sheet;
S2: disposing one or more main bodies arranged at intervals on a hot-pressing tool;
S3: placing the heating element sheet on the main bodies, each said heating element being correspondingly positioned on one said main body;
S4: fixing the heating elements on the main bodies by hot-pressing; and
S5: removing margin waste of the heating element sheet by cutting to separate the heating elements from the heating element sheet and form the atomization assembly by each said heating element and one said main body.

8. The manufacturing method for the atomization assembly according to claim 7, wherein S1 further comprises: preparing one or more pairs of conductors arranged at intervals on a conductor sheet;
S3 further comprises: disposing the conductor sheet on the heating element sheet with each pair of conductors corresponding to one said heating element.

9. A manufacturing method for the atomization assembly according to claim 1, comprising the following steps:
S1: preparing one or more heating elements arranged at intervals on a heating element sheet;
S2: placing the heating element sheet in an injection mould, the injection mould being provided with one or more main body cavities arranged at intervals therein, each said heating element corresponding to one said main body cavity;
S3: injecting molten material of the main body into the main body cavities of the injection mould, the molten material of the main body being cured in the main body cavities to form main bodies, the heating elements being fixed on the main bodies;
S4: taking the heating element sheet with the main bodies out of the injection mould; and
S5: removing margin waste of the heating element sheet by cutting to separate the heating elements from the heating element sheet and form the atomization assembly by each said heating element and one said main body.

10. The manufacturing method for the atomization assembly according to claim 9, wherein S1 further comprises: disposing conductors on the heating element sheet, two ends of each said heating element being provided with the conductors.
